(19) United States
(12) Patent Application Publication
(10) Pub. No.: US 2026/0037133 A1
(43) Pub. Date: Feb. 5, 2026

(54) SETTING TERMINATION IMPEDANCE BASED ON ENCODING BITS IN A COMMAND

(71) Applicant: Micron Technology, Inc., Boise, ID (US)

(72) Inventors: Gary Howe, Boise, ID (US); David Brown, Boise, ID (US); Parthasarathy Gajapathy, Boise, ID (US)

(73) Assignee: Micron Technology, Inc., Boise, ID (US)

(21) Appl. No.: 19/270,980

(22) Filed: Jul. 16, 2025

Related U.S. Application Data
(60) Provisional application No. 63/677,969, filed on Jul. 31, 2024.

(51) Int. Cl. G06F 3/06

(52) U.S. Cl. CPC G06F 3/0611; G06F 3/0659; G06F 3/0673

(57) ABSTRACT

Apparatuses, systems, and methods for setting termination impedance based on encoding bits are disclosed. A memory receives an access command including one or more encoding bits, which may be received via one or more CA pins. Based on the one or more encoding bits and a setting in a mode register, the memory determines whether it is a target of the access command, and the memory applies a termination impedance based at least in part on the determination of whether it is the target of the access command. In various embodiments, the determination of whether the memory is the target can be performed in a single cycle.

### BACKGROUND

This disclosure relates generally to semiconductor devices, and more specifically to semiconductor memory devices. For example, disclosed embodiments may relate to volatile memory, such as dynamic random-access memory (DRAM). Information may be stored on individual memory cells of the memory device as a physical signal (e.g., a charge on a capacitive element). During a read operation the physical signal (e.g., the charge) may be coupled to a conductive element to cause a change in voltage. That change in voltage may be amplified and read out to input/output terminals of the device. A write operation may reverse the process, receiving a signal at the terminals and providing a voltage to the memory cell (e.g., to charge the capacitor).

Because voltages may be rapidly applied to the terminals, it may be important to prevent stray voltages from being reflected at the terminals where the memory device interfaces with outside devices. The memory device may have multiple selectable termination legs, which are used to match impedance. It may be important to tune the resistance of the termination resistors.

### BRIEF DESCRIPTION OF THE DRAWINGS

FIG. 1A is a block diagram of a memory system according an embodiment of the disclosure.

FIG. 1B is a block diagram of a system according to an embodiment of the disclosure.

FIG. 2 is a block diagram of a memory device according an embodiment of the disclosure.

FIG. 3A is a table illustrating access commands according to some embodiments of the present disclosure.

FIG. 3B is a block diagram illustrating decoding an access command according to an embodiment of the disclosure.

FIG. 4 is a table illustrating controlling termination impedance using encoding bits according to some embodiments of the present disclosure.

FIG. 5A is a timing chart illustrating controlling termination impedance using encoding bits according to some embodiments of the present disclosure.

FIG. 5B is a timing chart illustrating controlling termination impedance using encoding bits according to some embodiments of the present disclosure.

FIG. 5C is a timing chart illustrating controlling termination impedance using encoding bits according to some embodiments of the present disclosure.

FIG. 5D is a timing chart illustrating controlling termination impedance using encoding bits according to some embodiments of the present disclosure.

FIG. 6 is a table illustrating controlling termination impedance using encoding bits according to some embodiments of the present disclosure.

### DETAILED DESCRIPTION

The following description of certain embodiments is merely illustrative in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Information in a memory device is stored in a memory array. The information is conveyed as voltages along various internal signal lines. For example, a first voltage may represent a logical high, while a second voltage may represent a logical low. During access operations, such as read and write operations, the signals may be passed to and from the device between data terminals (DQ terminals) of the device and a data bus (DQ) bus which couples the device to a controller. The memory device includes input/output (IO) circuits, which couple the internal signals to the DQ terminals and DQ bus. The IO circuit includes a termination circuit, which includes one or more selectable resistive legs, each of which include a tunable resistor. The resistive legs may be coupled in parallel, and a number of the resistive legs which are active (e.g., a number of the tunable resistors coupled in parallel) may determine an overall impedance of the termination circuit. This in turn ensures that the impedance of the terminals (e.g., as set by the termination circuit) matches the impedance along the line (e.g., the DQ bus) to help ensure that there are not voltage reflections at the DQ terminal. This may be especially important in a memory system, such as a memory module, where multiple memory devices may share the same DQ terminals.

During operations, the controller may direct commands to one or more ‘target’ memory devices on the module while ‘non-target’ memory devices remain idle. On-die termination impedance of respective termination circuits may be adjusted, for example, based on whether a memory device is a target or a non-target.

Memory devices in a memory module may have different ranks, and the different ranks allow the memory devices to be operated in different ways. Each rank may include one or more memory devices. In some memory modules, multiple ranks may share the same DQ terminals. A controller may direct access commands to a ‘target’ rank, which causes all memory devices of the ‘target’ rank to perform an access operation, while memory devices of a ‘non-target’ rank do not perform the access operation. A memory device may determine whether it is a target based on a state of a chip select (CS) signal during consecutive cycles. But using a CS signal to determine whether a memory device is a target increases latency.

The present disclosure is drawn to setting on-die termination impedance based on one or more encoding bits in a command, which may be one or more bits in an access command received via one or more command/address (CA) pins of a memory device. In embodiments of the disclosed technology, the memory device determines whether it is a target of the command based on the one or more bits received via the one or more CA pins, rather than using the state of the CS signal during consecutive cycles. Advantageously, the disclosed technology may allow the determination of whether the memory is a target in fewer cycles (e.g., in a single cycle). The memory device may apply an on-die termination impedance based on the determination of whether the memory device is a target of the command.

In embodiments of the disclosed technology, memory devices can be associated with different ranks that are operated differently, such that one or more ranks may be a target rank of a command while one or more other ranks may be a non-target rank of the command. In these and other embodiments, mode registers of memory devices in the respective ranks may be programmed (e.g., using a mode register write command) with information that is used to determine that they are a target of a command based on different encoding bits. For example, an encoding bit at a low logic level may indicate that a first rank is a target rank, while an encoding bit at a high logic level may indicate that a second rank is a target rank. Additionally, respective on-die termination settings may be configured in the mode register for different operations (e.g., write, read, non-target write, non-target read, deselect (DSEL)). Examples of on-die termination impedances that may be applied include RTT_NOM_RD, RTT_NOM_WR, RTT_PARK, RTT_WR, or DQS_RTT_PARK.

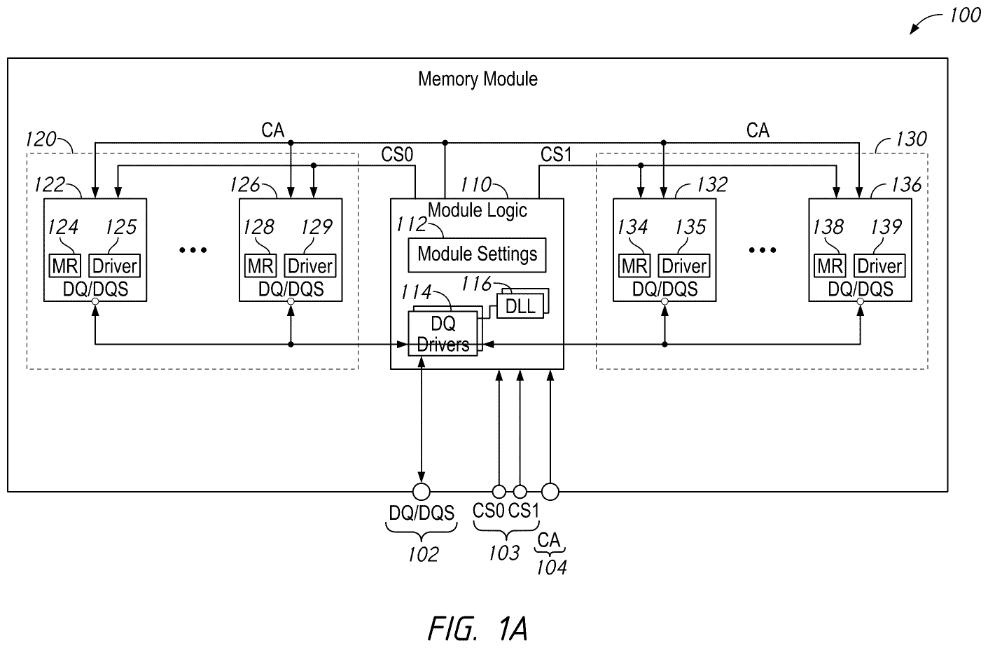

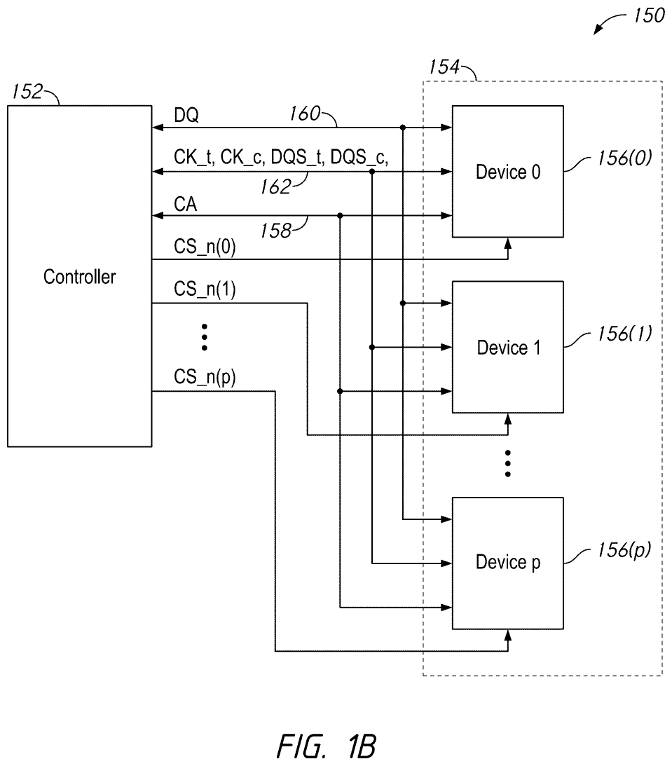

FIG. 1A is a block diagram of a memory system 100 according an embodiment of the disclosure. The memory system 100 may be a memory module, which packages together multiple memory devices (e.g., memory dice 122, 126, 132, 136). Each memory device includes a memory array that stores information in memory cells. A controller (not shown) accesses one or more of the memory devices by passing commands and addresses along command and address (CA) terminals 104 and sends and receives data to/from one or more memory devices along external data terminals (DQ/DQS) 102. Additionally, the controller provides one or more chip select (CS) signals along CS terminals (CS0/CS1) 103. The memory system 100 includes module logic 110, which may include a buffer which acts to help routing of command, address, and/or data between the external terminals of the module (e.g., the CA terminals 104, CS terminals 103, and DQ terminals 102) and the corresponding terminal(s) of the memory devices. For example, each memory device may have CA and DQ terminals, coupled to the external terminals through the module logic 110. The module logic 110 includes output (or DQ) drivers 114 which receive data signals from the accessed memory devices and then drive the external terminals 102 based on those internal signals.

The memory devices on the memory system 100 may be organized into ranks. For example, the memory system 100 in FIG. 1 shows two ranks 120 and 130. More or fewer ranks per module may be used in other example embodiments. Each rank includes a number of memory devices. For example, the first rank 120 includes at least memory dice 122 and 126, while the second rank 130 includes at least memory dice 132 and 136. For the sake of brevity, only four memory devices (memory dice 122, 126, 132, and 136) are shown. However, more or fewer memory devices per rank may be used in other example embodiments.

During an example access operation, the memory system 100 receives an access command and addresses along external CA terminals 104. The access command may also include a CS signal along a CS terminal 103, such as a first CS signal CS0 routed to the first rank 120 or a second CS signal CS1 routed to the second rank 130.

The output driver circuits 114 may contain synchronizer circuits which may synchronize the data to a delayed clock signal provided by a delay circuit 116. The delayed clock signal may mimic a latency of the memory to ensure that the data arrives a specified number of clock cycles after the read command was received. For example, the delay circuit 116 may have an adjustable delay which is matched to the latency. In some embodiments, the delay circuits 116 may be shared by the output circuits 114 associated with a memory. In some embodiments, the delay circuits 116 may be shared between memory devices. For example, the delay circuits 116 may be shared based on distance from the module logic 110 (e.g., shared based on expected latency). For example, memory die 126 and memory die 132 may share a delay circuit 116, and memory die 126 and memory die 132 may share a second delay circuit.

The memory system 100 includes a set of internal data buses which couple each memory's DQ pads to the module logic 110. The data buses include one or more conductive elements, and the voltage(s) along the data buses represent data being transmitted to/from the memory. For example, a first voltage may represent a high logical level, while a second voltage may represent a low logical level. In some embodiments, other arrangements may be used, for example, multi-level signaling where multiple bits are provided across a single signal line by using more than two voltages to represent the logical states of multiple bits. Similarly, in some embodiments, more data bus lines may be used than there are external terminals associated with that memory. In such embodiments, the output drivers 114 may include decoders to receive the data and split it into the appropriate number of outputs.

The module logic 110 includes a module settings register 112. The module settings register 112 may be a set of programmable registers, which are used to set one or more values for the operation of the memory system 100. The module settings register 112 may act in a fashion analogous to the mode registers of the memory devices. Each memory device may have a mode register, which includes a number of registers which store values related to the operation of the memory. For example, memory die 122 includes mode register 124, memory die 126 includes mode register 128, memory die 132 includes mode register 134, and memory die 136 includes mode register 138. The module settings register 112 (optionally in conjunction with the mode registers of the memory devices) may work to enable various settings of the memory device. In various embodiments, settings in the mode register of each memory device can be configured to cause a respective memory device to determine whether it is a target of a command based on one or more encoding bits in the command, and settings in the mode register may specify respective termination impedances to be applied based on the one or more encoding bits and/or the logic level of a respective CS signal. For example, different termination impedances may be specified for a write operation, a read operation, a non-target write operation, a non-target read operation, or a DSEL operation.

FIG. 1B is a block diagram of a system 150 according to an embodiment of the disclosure. The system 150 includes a controller 152 and a memory system 154. In the illustrated embodiment, the memory system 154 includes memory devices 156(0)-156(p) (e.g., “Device 0” through “Device p”), where p is a number greater than one (1).

In one embodiment, the memory system 154 is a memory module (e.g., 100 of FIG. 1A) and the memory devices 156(0)-156(p) are memory ranks. The memory devices 156(0)-156(p) may include a dynamic random access memory (DRAM), a double data rate (DDR) memory, a low power double data rate (LPDDR) memory, a graphics double data rate (GDDR) memory, or other type of memory. Each memory rank can include one or more memory devices (e.g., DRAM devices).

The memory devices 156(0)-156(p) are each coupled to the command/address, data, and clock busses. The controller 152 and the memory system 154 are in communication over one or more busses. Commands and addresses (CA) are received by the memory system 154 on a command/address bus 158, and data (DQ) is provided between the controller 152 and the memory system 154 over a data bus 160. Various clocks may be provided between the controller 152 and the memory system 154 over a clock bus 162. The clock bus 162 may include signal lines for providing system clocks CK_t and CK_c received by the memory system 154 and data clocks (strobes) DQS_t and DQS_c received by the memory system 154 and/or provided to the controller 152. Each of the busses may include one or more signal lines on which signals are provided.

The CK_t and CK_c clocks provided by the controller 152 to the memory system 154 are used for timing the provision and receipt of the commands and addresses. The DQS_t and DQS_c clocks are used for timing provision of data. The CK_t and CK_c clocks are complementary, and the DQS_t and DQS_c clocks are complementary. Clocks are complementary when a rising edge of a first clock occurs at a same time as a falling edge of a second clock, and when a rising edge of the second clock occurs at a same time as a falling edge of the first clock.

The controller 152 provides commands to the memory system 154 to perform memory operations. Examples of memory commands include timing commands for controlling the timing of various operations, explicit power-down entry and exit commands and commands for auto power-down for controlling entry into power-down, access commands for accessing the memory, such as read commands for performing read operations and write commands for performing write operations, activation commands, refresh command, activate command, precharge command, deselect command, no operation commands, as well as other commands. The command signals provided by the controller 152 to the memory system 154 further include external control signals (e.g., chip select signals CS_n(0), CS_n(1), CS_n(p)).

The memory devices 156 (0)-156(p) are provided the commands, addresses, data, and clocks, and the external control signals. The memory devices 156(0)-156(p) determine whether they are a target of a command based on received encoding bits in a command, and target memory devices (e.g., in a target rank) perform operations (e.g., access operations) responsive to the command.

In operation, when a read command and associated address are provided by the controller 152 to the memory system 154, the memory devices 156(0)-156(p) determine whether they are a target of the read command based on one or more encoding bits in the read command, and one or more target memory devices perform a read operation to provide the controller 152 with read data from a memory location corresponding to the associated address. The read data is provided by the target memory device to the controller 152 according to a timing relative to receipt of the read command. For example, the timing may be based on a read latency (RL) value that indicates the number of clock cycles of the CK_t and CK_c clocks (a clock cycle of the CK_t and CK_c clocks is referenced as tCK) after the read command when the read data is provided by the target memory device to the controller 152. One or more non-target memory devices do not perform the read operation, and the one or more non-target memory devices may adjust a termination resistance for read non-target.

Mode registers included in each of the memory devices 156(0)-156(p) may be programmed with information for setting various operating modes and/or to select features for operation of the memory devices 156(0)-156(p). One of the settings may be for decoding the encoding bits to determine whether a memory device is a target of a command.

In preparation of the target memory device providing the read data to the controller 152, the target memory device provides active data clocks DQS_t and DQS_c. A clock is active when the clock transitions between low and high clock levels periodically. Conversely, a clock is inactive when the clock maintains a constant clock level and does not transition periodically. The DQS_t and DQS_c clocks are provided by the target memory device performing the read operation to the controller 152 for timing the provision of read data to the controller 152. The controller 152 may use the DQS_t and DQS_c clocks for receiving the read data.

In operation, when a write command and associated address are provided by the controller 152 to the memory system 154, the memory device 156(0)-156(p) determine whether they are a target of the write command based on one or more encoding bits in the write command, and one or more target memory devices perform a write operation to write data from the controller 152 to a memory location corresponding to the associated address. The write data is provided to the target memory device by the controller 152 according to a timing relative to receipt of the write command. For example, the timing may be based on a write latency (WL) value that indicates the number of clock cycles of the CK_t and CK_c clocks after the write command when the write data is provided to the target memory device by the controller 152. One or more non-target memory devices do not perform the write operation, and the one or more non-target memory devices may adjust a termination resistance for write non-target.

In preparation of the target memory device receiving the write data from the controller 152, the controller 152 provides active data clocks DQS_t and DQS_c to the memory system 154. The DQS_t and DQS_c clocks may be used by the target memory device to generate internal clocks for timing the operation of circuits to receive the write data. The data is provided by the controller 152 and the target memory device receives the write data according to the DQS_t and DQS_c clocks, which is written to a memory location corresponding to the memory address.

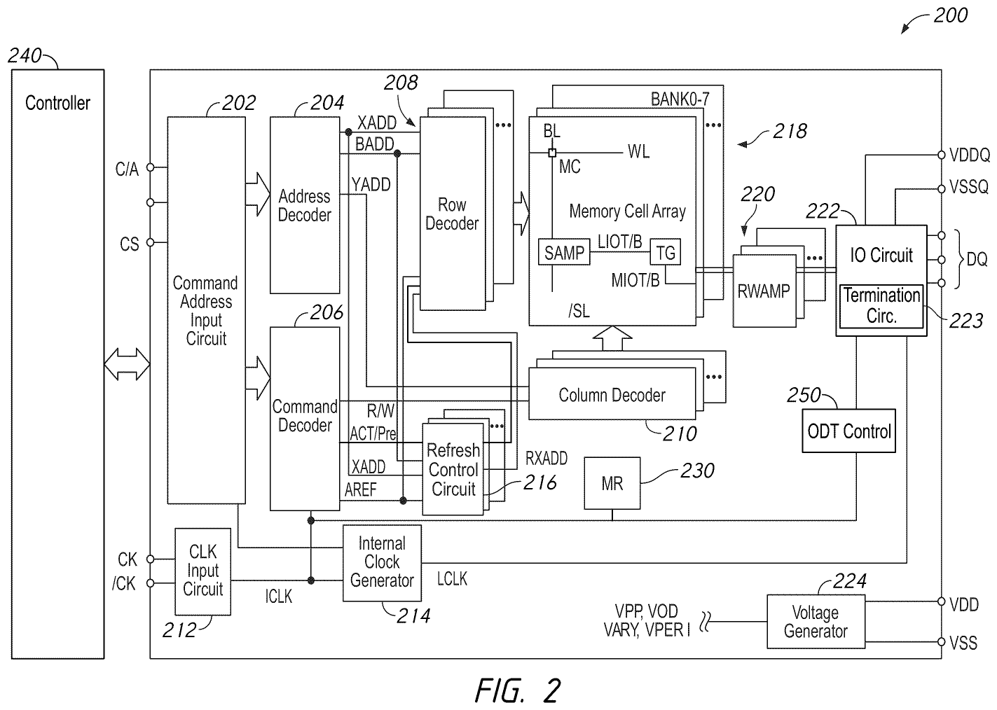

Mode register write commands and mode register read commands can be used to access mode registers in the memory devices 156(0)-156(p) (e.g., mode register 230 in FIG. 2). For example, a mode register write command can be provided by the controller 152 to respective memory devices 156(0)-156(p) to configure each memory device to determine that it is a target for an access command based on one or more encoded bits in an access command.

FIG. 2 is a block diagram of a memory device 200 according an embodiment of the disclosure. The memory device 200 may be, for example, a DRAM device integrated on a single semiconductor chip. The memory device 200 may be a die of a memory system, such as one of memory dice 122, 126, 132, and 136 of FIG. 1A or one of memory devices 156(0)-156(p) of FIG. 1B.

The memory device 200 includes a memory array 218. The memory array 218 is shown as including a plurality of memory banks. In the embodiment of FIG. 2, the memory array 218 is shown as including eight memory banks BANK0-BANK7. More or fewer banks may be included in the memory array 218 of other embodiments. For example, memory devices 200 may include 4, 16, or 32 banks. Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 208, and the selection of the bit lines BL is performed by a column decoder 210. In the embodiment of FIG. 2, the row decoder 208 includes a respective row decoder for each memory bank and the column decoder 210 includes a respective column decoder for each memory bank. The bit lines BL are coupled to a respective sense amplifier (SAMP). Read data from the bit line BL is amplified by the sense amplifier SAMP and transferred to read/write amplifiers 220 over complementary local data lines (LIOT/B), transfer gate (TG), and complementary main data lines (MIOT/B). Conversely, write data outputted from the read/write amplifiers 220 is transferred to the sense amplifier SAMP over the complementary main data lines MIOT/B, the transfer gate TG, and the complementary local data lines LIOT/B, and written in the memory cell MC coupled to the bit line BL.

The memory device 200 may employ a plurality of external terminals that include command and address (C/A) terminals coupled to a command and address bus to receive commands and addresses, and a CS signal, clock terminals to receive clocks CK and/CK, data terminals DQ to provide data, and power supply terminals to receive power supply potentials VDD, VSS, VDDQ, and VSSQ. The external terminals may be coupled to a controller 240, which may operate the memory by providing various signals to the external terminals.

The controller 240 provides the clock terminals with external clocks CK and/CK that are provided to an input circuit 212. The external clocks may be complementary. The input circuit 212 generates an internal clock ICLK based on the CK and/CK clocks. The ICLK clock is provided to the command decoder 206 and to an internal clock generator 214. The internal clock generator 214 provides various internal clocks LCLK based on the ICLK clock. The LCLK clocks may be used for timing operation of various internal circuits. The internal data clocks LCLK are provided to the input/output circuit 222 to time operation of circuits included in the input/output circuit 222, for example, to data receivers to time the receipt of write data.

The controller 240 provides the C/A terminals with commands and memory addresses. There may be a command/address bus which couples the controller 240 to the C/A terminals of the memory device 200. For example, there may be a set of C/A terminals or pins, each coupled to a conductive element of the C/A bus.

The memory addresses supplied to the C/A terminals are transferred, via a command/address input circuit 202, to an address decoder 204. The address decoder 204 receives the address and supplies a decoded row address XADD to the row decoder 208 and supplies a decoded column address YADD to the column decoder 210. The address decoder 204 may also supply a decoded bank address BADD, which may indicate the bank of the memory array 218 containing the decoded row address XADD and column address YADD.

The controller 240 may provide the C/A terminals with commands. Examples of commands include timing commands for controlling the timing of various operations, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed.

Control commands may be provided as internal command signals to a command decoder 206 via the command/address input circuit 202. The command decoder 206 includes circuits to decode the internal command signals to generate various internal signals and commands for performing operations. For example, the command decoder 206 may provide a row command signal to select a word line and a column command signal to select a bit line. The command decoder 206 also provides activation and pre-charge signals to the different banks of the memory. An activation signal ACT may indicate that a word line in that bank should be activated, while a pre-charge signal Pre may indicate that the word lines should be pre-charged (e.g., closed) in anticipation of a next activation command. In some embodiments, the ACT and Pre signals may share a signal line.

The device 200 may receive commands and addresses from the controller 240 as part of an access operation, such as a read operation. As part of the access operation, a row address and bank address are received along with an activate command. As part of the access operation, a column address and bank address are received along with a read command. Responsive to the read operation, read data is read from memory cells in the memory array 218 corresponding to the row address and column address. The commands associated with the read operation are received by the command decoder 206, which provides internal commands so that read data from the memory array 218 is provided to the read/write amplifiers 220. Responsive to the activate command the row decoder 208 activates a word line associated with the row address. While the row is active, memory cells along that row are coupled to sense amplifiers activated by the column decoder 210 responsive to the read command to read data out along the LIOT/B lines. The read data is output to outside from the data terminals DQ via the input/output circuit 222. The command decoder 206 may then provide a pre-charge command which may ‘close’ the active row. In various embodiments, the device 200 may perform the access operation when it is determined to be a target of the received command based on one or more encoding bits in the command and a setting in the mode register 230.

The device 200 may receive commands and addresses from the controller 240 as part of an access operation, such as a write operation. As part of the write operation, a row address and bank address are received along with an activated command and a column address and bank address are received along with write data and a write command. Responsive to the write operation, write data supplied to the data terminals DQ is written to a memory cells in the memory array 218 corresponding to the row address and column address. The commands associated with the write operation are received by the command decoder 206, which provides internal commands so that the write data is received by data receivers in the input/output circuit 222. Responsive to the activate command the row decoder 208 activates a word line associated with the row address. While the row is active, memory cells along that row are coupled to sense amplifiers activated by the column decoder 210 responsive to the write command to receive write data. Write clocks may also be provided to the external clock terminals for timing the receipt of the write data by the data receivers of the input/output circuit 222. The write data is supplied via the input/output circuit 222 to the read/write amplifiers 220, and by the read/write amplifiers 220 to the memory array 218 to be written into the memory cell MC. The command decoder 206 may then provide a pre-charge command which may ‘close’ the active row. In various embodiments, the device 200 may perform the access operation when it is determined to be a target of the received command based on one or more encoding bits in the command and a setting in the mode register 230.

The device 200 may also perform refresh operations. The refresh operations may be performed as part of an auto-refresh operation, where a controller 240 issues an auto-refresh command or as part of a self-refresh operation, where the memory refreshes itself based on internal commands. The refresh control circuit 216 supplies a refresh row address RXADD to the row decoder 208, which may refresh one or more wordlines WL indicated by the refresh row address RXADD. In some embodiments, the refresh address RXADD may represent a single wordline. In some embodiments, the refresh address RXADD may represent multiple wordlines, which may be refreshed sequentially or simultaneously by the row decoder 208. In some embodiments, the number of wordlines represented by the refresh address RXADD may vary from one refresh address to another. The refresh control circuit 216 may be controlled to change details of the refreshing address RXADD (e.g., how the refresh address is calculated, the timing of the refresh addresses, the number of wordlines represented by the address), or may operate based on internal logic.

The IO circuit 222 includes a termination circuit 223. The termination circuit 223 provides a calibrated impedance value to the DQ terminals, for example to match the impedance of the DQ terminals to the line impedance of the DQ bus between the DQ terminals and the controller 240. The termination circuit 223 includes a number of tunable resistors, which may be selectively coupled to the DQ terminals to provide a chosen impedance. The chosen impedance may be a setting based on properties of the controller and/or DQ bus. For example, the termination circuit 223 includes a number of selectable resistive legs, each with a tunable resistor of NΩ. If X of the tunable legs are active, then the overall value may be (N/X) Ω. For example, if 240Ω resistors are used, then overall values such as 60Ω (four active legs), 40Ω (six active legs), and 30Ω (seven active legs) may be selected. Other values of the resistor and other numbers of legs may be used in other example embodiments.

Each of the tunable resistors may be adjustable in order to ensure that the impedance can be matched to a nominal value (for example, to ensure that each tunable resistor matches a value of 240Ω). The memory may have access to a reference resistor ZQ (not shown in FIG. 2), which has the nominal value. The reference resistor ZQ may be a resistor manufactured with narrow tolerances (e.g., 5%, 1%, or 0.1% etc.) As part of the calibration operation, the resistance of each of the tunable resistors of the termination circuit 223 is adjusted to match the resistance of the reference resistor ZQ.

The device 200 includes a mode register 230 that may be used to control various modes of the device 200. For example, the mode register 230 may include a setting which is used to determine whether the device 200 is a target for a command received from the controller 240 based on one or more encoding bits in the command. The controller 240 may provide a mode register write (MRW) command to set values in the mode register 230, such as to configure settings for determining whether the device 200 is a target of a command based on encoding bits. The settings may include one or more mode register bits that are used by the command decoder 206 to evaluate received encoding bits in an access command (e.g., to determine a match) and determine whether the memory device 200 is a target for the access command. In an example implementation, the memory device 200 is determined to be a target for the access command when the encoding bits match the mode register bits. An impedance of the termination circuit 223 may be adjusted based on the target/non-target determination (e.g., impedances for write, read, non-target write, non-target read, DSEL). The mode register 230 includes a number of registers, each of which may store one or more bits which correspond to a setting or piece of information about the device 200.

The impedance provided by the termination circuit 223 may be set based on various factors, such as whether the semiconductor device 200 is a target of an access command and/or a logic level of a CS signal. For example, an access command may include one or more encoding bits received via one or more C/A pins, and command decoder 206 is configured to determine whether the memory device 200 is a target of the access command based on the one or more encoding bits and a setting in the mode register 230. The ODT control circuit 250 may set the impedance provided by the termination circuit 223 based at least in part on the determination of whether the semiconductor device 200 is the target of the access command.

The power supply terminals are supplied with power supply potentials VDD and VSS. The power supply potentials VDD and VSS are supplied to an internal voltage generator circuit 224. The internal voltage generator circuit 224 generates various internal potentials VPP, VOD, VARY, VPERI, and the like based on the power supply potentials VDD and VSS supplied to the power supply terminals. The internal potential VPP is mainly used in the row decoder 208, the internal potentials VOD and VARY are mainly used in the sense amplifiers SAMP included in the memory array 218, and the internal potential VPERI is used in many peripheral circuit blocks.

The power supply terminals are also supplied with power supply potentials VDDQ and VSSQ. The power supply potentials VDDQ and VSSQ are supplied to the input/output circuit 222. The power supply potentials VDDQ and VSSQ supplied to the power supply terminals may be the same potentials as the power supply potentials VDD and VSS supplied to the power supply terminals, or the power supply potentials VDDQ and VSSQ supplied to the power supply terminals may be different potentials from the power supply potentials VDD and VSS supplied to the power supply terminals. The power supply potentials VDDQ and VSSQ supplied to the power supply terminals may be used for the input/output circuit 222 so that power supply noise generated by the input/output circuit 222 does not propagate to the other circuit blocks.

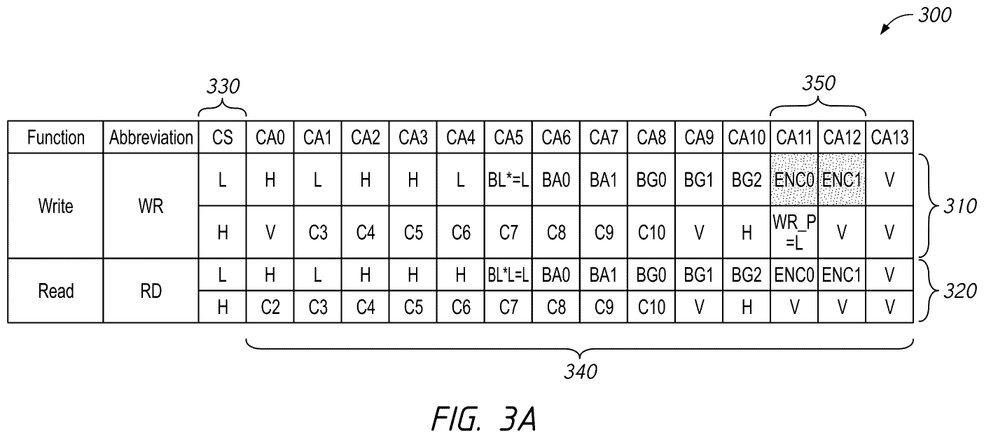

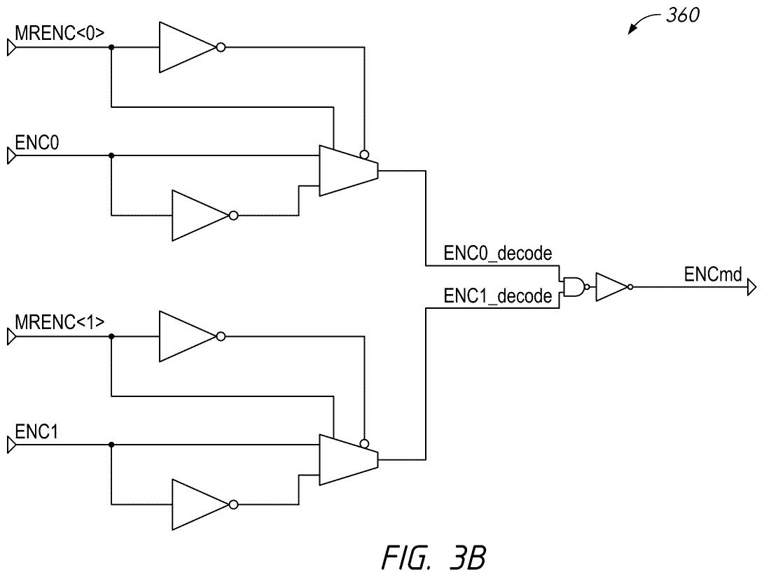

FIG. 3A is a table 300 illustrating access commands according to some embodiments of the present disclosure. The table 300 may represent at least a portion of a command truth table illustrating command/address inputs received by a memory device via CA pins and a chip select signal. A first command 310 comprises a write command, and a second command 320 comprises a read command.

Each command is provided to the memory device across one or more cycles (e.g., clock cycles). Each command comprises one or more CS signals 330 and CA signals 340, which may be bits having a first logic level or a second logic level, each having respective voltages (e.g., a high voltage or a low voltage). The CA signals 340 are provided to the memory via CA pins. While existing technologies may use CS signals 330 across multiple cycles to determine whether a memory device is a target of a command, the disclosed technology includes one or more encoding bits 350, which can be used to control on-die termination of a memory (e.g., by rank). In some implementations, the determination of whether the memory device is the target of the command can be performed in a single cycle based on the one or more encoding bits 350.

A memory device may receive the first command 310 or the second command 320 via CA pins and a CS line. A command decoder of the memory device can determine whether the memory device is a target of the respective command based on a value of the one or more encoding bits 350 and a setting in a mode register of the memory device, and an ODT control circuit of the memory device can set termination impedance based on the determination of whether the memory device is the target. In various embodiments, the memory may be associated with a rank, which can be determined as a target rank or a non-target rank based on the one or more encoding bits 350 and the setting in the mode register of the memory. In various embodiments, a logic level of the CS signal 330 is used to identify a DSEL command, such that a termination impedance for the DSEL command is applied based on the logic level of the CS signal 330.

While two encoding bits 350 are illustrated in the table 300, more or fewer encoding bits 350 may be used. For example, one encoding bit 350 can be used to determine whether a memory device is a target where a memory system (e.g., memory module) includes two ranks.

FIG. 3B is a block diagram 360 illustrating decoding an access command according to an embodiment of the disclosure. In the illustrated example, a command decoder (e.g., 206 of FIG. 2) decodes a command (e.g., 310 or 320 of FIG. 3A) to determine whether a memory device is a target or a non-target of the access command. The decoding of the access command is performed using mode register bits MRENC<0> and MRENC<1> programmed in a mode register (e.g., 230 of FIG. 2) and encoding bits ENC0 and ENC1 (e.g., 310 of FIG. 3A).

The command decoder receives mode register bit MRENC<0> from the mode register and encoding bit ENC0, which is included in the access command. The command decoder evaluates the encoding bit ENC0 based on the mode register bit MRENC<0> to generate a first processing result ENC0_decode. For example, ENC0_decode may have a value of 1 when ENC0 matches MRENC<>, and ENC0_decode may have a value of 0 when ENC0 does not match MRENC<0>.

The command decoder receives mode register bit MRENC<1> from the mode register and encoding bit ENC1, which is included in the access command. The command decoder evaluates the encoding bit ENC1 based on the mode register bit MRENC<1> to generate a second processing result ENC1_decode. For example, ENC1_decode may have a value of 1 when ENC1 matches MRENC<1>, and ENC1_decode may have a value of 0 when ENC1 does not match MRENC<1>.

The command decoder evaluates the first processing result ENC0_decode and the second processing result ENC1_decode to generate a third processing result ENCmd. For example, ENCmd may have a value of 1 when both ENC0_decode=1 and ENC1_decode=1—that is, when ENC0 matches MRENC<0> and ENC1 matches MRENC<1>. Otherwise, ENCmd may have a value of 0. When ENCmd=1, the memory device may determine that it is a target of the access command, and the memory device may perform an access operation responsive to the access command. When ENCmd=0, the memory device may determine that it is a non-target of the access command, and the memory device may be configured accordingly (e.g., by setting a termination impedance for non-target read or non-target write).

While the illustrated example describes determining whether an encoding bit matches a respective mode register bit, one or both values may be inverted in other embodiments. Additionally, more or fewer encoding bits may be used in other embodiments. For example, one encoding bit and one mode register bit may be used in embodiments with two ranks.

The mode register bits MRENC<0> and MRENC<1> can be specified in a mode register write command (e.g., on a per rank basis), and different values of mode register bits MRENC<0> and MRENC<1> may be programmed according to a rank of a memory device.

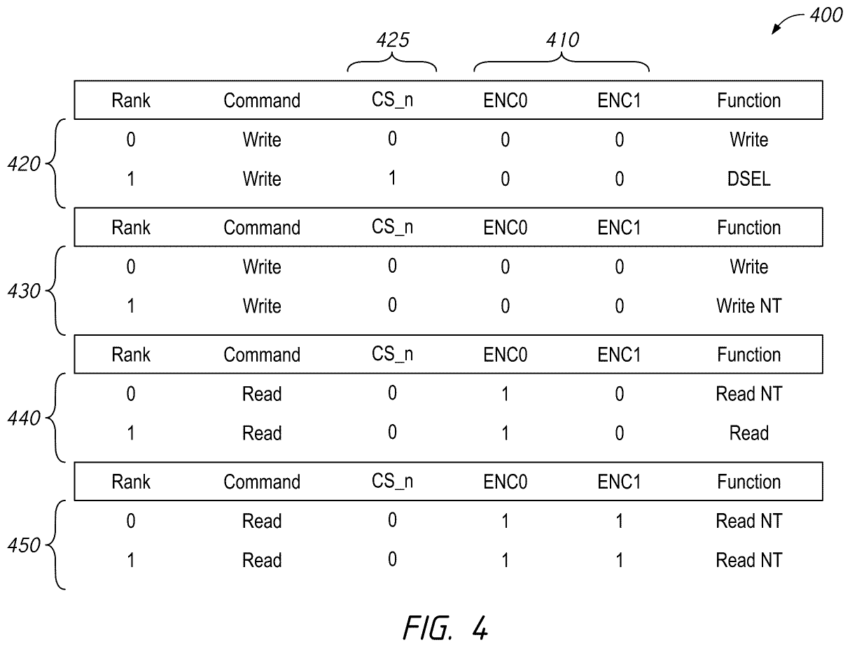

FIG. 4 is a table 400 illustrating controlling termination resistances using encoding bits 410 according to some embodiments of the present disclosure. In the illustrated embodiment, a plurality of memory devices are associated with respective ranks comprising a rank 0 and a rank 1 (e.g., 120 and 130 of FIG. 1), and memory devices in each respective rank are configured to determine that they are a target of a respective command based on the encoding bits 410 (e.g., 350 of FIG. 3) included in the command received via CA pins. For example, memory devices associated with the rank 0 are configured to determine that they are a target for a command when encoding bit ENC0-0 and encoding bit ENC1=0, and memory devices associated with rank 1 are configured to determine that they are a target for a command when encoding bit ENC0=1 and encoding bit ENC1=0. Each memory device is configured to evaluate a received command based on a setting in a respective mode register to determine whether the memory is a target for the received command. Each memory device may set a respective termination resistance based on the determination whether the memory is the target for the received command. Additionally or alternatively, each memory may perform a DSEL operation based on a logic level of a CS signal 425 (e.g., when CS_n=1).

In a first example, a write command 420 is received at one or more memory devices associated with rank 1 and rank 0. The write command 420 includes a plurality of bits received via CA pins of the one or more memory devices (e.g., as illustrated with reference to 340 of FIG. 3), and the write command 420 includes respective CS signals 425 for each rank. The write command 420 includes the encoding bits 410, which are received via one or more CA pins of the memory devices. In the illustrated example, encoding bit ENC0-0 and encoding bit ENC1=0 indicates that memory devices associated with rank 0 are targets for the write command 420. Memory devices associated with the rank 0 determine, based on the encoding bits 410, that they are the target for the write command 420 (e.g., based on a setting in a mode register), and the memory devices associated with the rank 0 may set a termination resistance to perform a write operation responsive to the write command 420. Memory devices associated with the rank 1 determine, based on the encoding bits 410, that they are a non-target for the write command 420 (e.g., based on a setting in a mode register), and the memory devices associated with the rank 1 may set a termination resistance accordingly (e.g., for deselect (DSEL), based on the CS signal 425).

In a second example, a write command 430 is received at one or more memory devices associated with rank 1 and rank 0. The write command 430 includes a plurality of bits received via CA pins of the one or more memory devices (e.g., as illustrated with reference to 340 of FIG. 3), and the write command 430 includes respective CS signals 425 for each rank. The write command 430 includes the encoding bits 410, which are received via one or more CA pins of the memory devices. In the illustrated example, encoding bit ENC0=0 and encoding bit ENC1=0 indicates that memory devices associated with rank 0 are targets for the write command 420. Memory devices associated with the rank 0 determine, based on the encoding bits 410, that they are the target for the write command 430 (e.g., based on a setting in a mode register), and the memory devices associated with the rank 0 may set a termination resistance to perform a write operation responsive to the write command 430. Memory devices associated with the rank 1 determined, based on the encoding bits 410, that they are a non-target for the write command 430 (e.g., based on a setting in a mode register), and the memory devices associated with the rank 1 may set a termination resistance accordingly (e.g., for write non-target, based on the CS signal 425).

In a third example, a read command 440 is received at one or more memory devices associated with rank 1 and rank 0. The read command 440 includes a plurality of bits received via CA pins of the one or more memory devices (e.g., as illustrated with reference to 340 of FIG. 3), and the read command 440 includes respective CS signals 425 for each rank. The read command 440 includes the encoding bits 410, which are received via one or more CA pins of the memory devices. In the illustrated example, encoding bit ENC0=1 and encoding bit ENC1=0 indicates that memory devices associated with rank 1 are targets for the read command 440. Memory devices associated with the rank 1 determine, based on the encoding bits 410, that they are the target for the read command 440 (e.g., based on a setting in a mode register), and the memory devices associated with the rank 1 may set a termination resistance to perform a read operation responsive to the read command 440. Memory devices associated with the rank 0 determine, based on the encoding bits 410, that they are a non-target for the read command 440 (e.g., based on a setting in a mode register), and the memory devices associated with the rank 0 may set a termination resistance accordingly (e.g., for read non-target, based on the CS signal 425).

In a fourth example, a read command 450 is received at one or more memory devices associated with rank 1 and rank 0. The read command 450 includes a plurality of bits received via CA pins of the one or more memory devices (e.g., as illustrated with reference to 340 of FIG. 3), and the read command 450 includes respective CS signals 425 for each rank. The read command 450 includes the encoding bits 410, which are received via one or more CA pins of the memory devices. In the illustrated example, encoding bit ENC0=1 and encoding bit ENC1=1 indicates that neither memory devices associated with rank 0 nor memory devices associated with rank 1 are targets for the read command 450—for example, a different rank, such as a rank 2 (not shown), may be the target for the read command 450. Memory devices associated with the rank 1 determine, based on the encoding bits 410, that they are a non-target for the read command 450 (e.g., based on a setting in a mode register), and the memory devices associated with the rank 1 may set a termination resistance accordingly (e.g., for read non-target, based on the CS signal 425). Memory devices associated with the rank 0 determine, based on the encoding bits 410, that they also are a non-target for the read command 450 (e.g., based on a setting in a mode register), and the memory associated with the rank 0 may set a termination resistance accordingly (e.g., for read non-target, based on the CS signal 425).

While two encoding bits 410 are illustrated in the table 400, more or fewer encoding bits 410 can be used. For example, one encoding bit 410 may be used in embodiments where a memory system uses two ranks.

In some implementations, for example, as previously described, memory devices associated with a rank may determine whether they are a target of a respective command in a single cycle, rather than in two or more cycles based on consecutive CS signals, because the determination of whether a memory is a target of the respective command is based on the encoding bits 410 received via one or more CA pins of the memory.

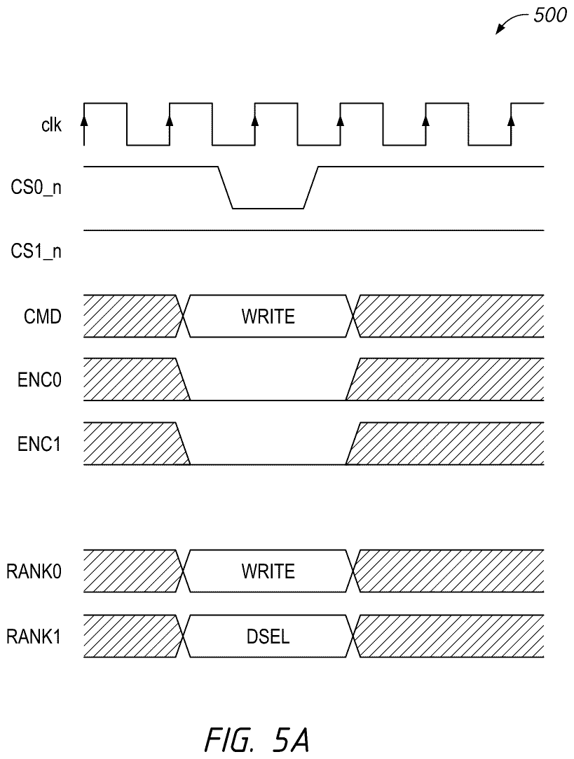

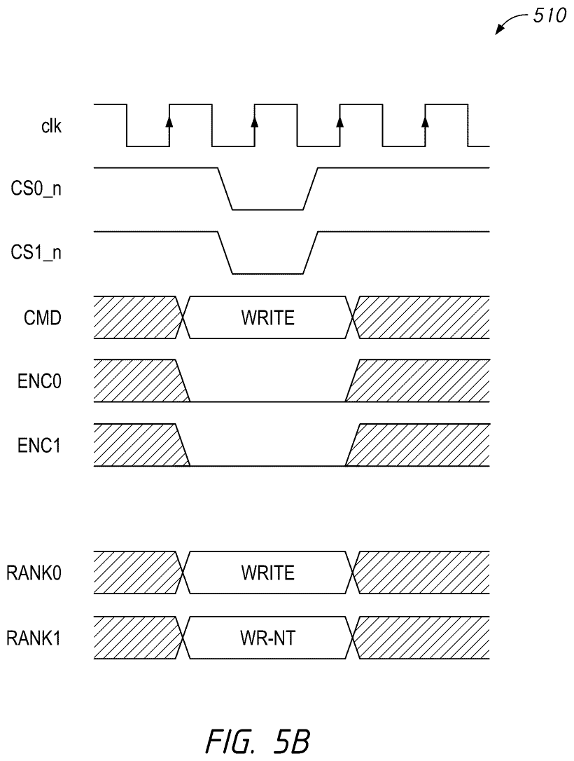

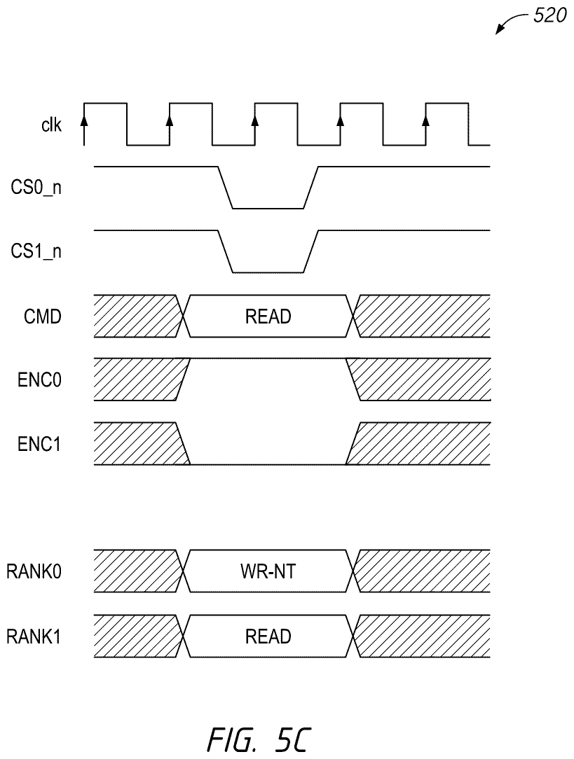

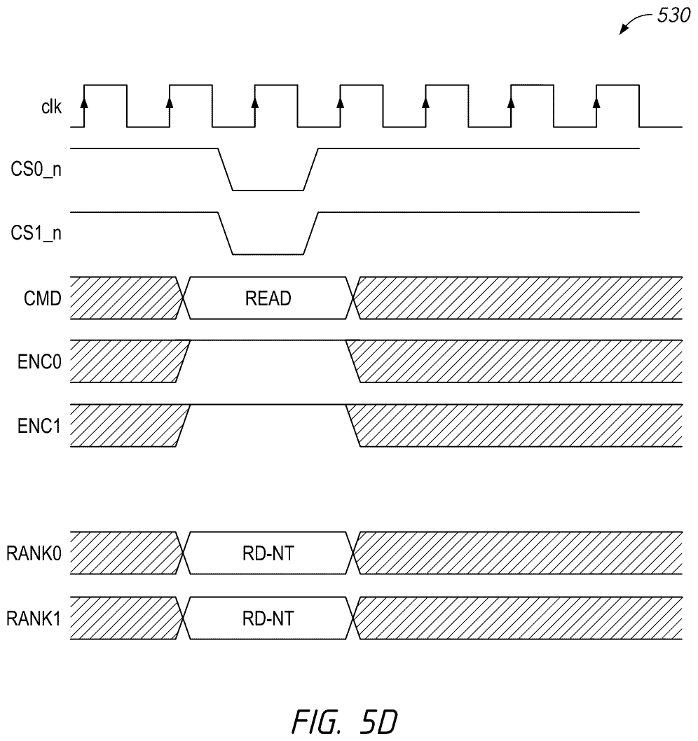

FIG. 5A is a timing chart 500 illustrating controlling termination resistance using encoding bits according to some embodiments of the present disclosure. The timing chart illustrates various signals or commands, including a clock signal clk, CS signals CS0_n and CS1_n, write command CMD, encoding bit ENC0, and encoding bit ENC1. One or more memory devices in a first rank RANK0 receive the write command CMD, including encoding bits ENC0 and ENC1, and a respective CS signal CS0_n. One or more memory devices in a second rank RANK1 receive the write command CMD, including encoding bits ENC0 and ENC1, and a respective CS signal CS1_n. The write command CMD may correspond to the write command 420 of FIG. 4. In the example, CS0_n=0, CS1_n=1, ENC0=0, and ENC1=0.

Responsive to the write command CMD, one or more memory devices in the first rank RANK0 determine that they are a target of the write command CMD based on the encoding bits ENC0 and ENC1 received via CA pins and a setting in a mode register, and the one or more memory devices in the first rank RANK0 set a termination resistance to perform a write operation responsive to the write command CMD. One or more memory devices in the second rank RANK1 determine that they are not a target of the write command CMD based on the encoding bits ENC0 and ENC1 received via CA pins and a setting in a mode register, and the one or more memory devices in the second rank RANK1 set a termination resistance accordingly (e.g., for DSEL, based on the CS signal CS1_n).

FIG. 5B is a timing chart 510 illustrating controlling termination resistances using encoding bits according to some embodiments of the present disclosure. The timing chart illustrates various signals or commands, including a clock signal clk, CS signals CS0_n and CS1_n, write command CMD, encoding bit ENC0, and encoding bit ENC1. One or more memory devices in a first rank RANK0 receive the write command CMD, including encoding bits ENC0 and ENC1, and a respective CS signal CS0_n. One or more memory devices in a second rank RANK1 receive the write command CMD, including encoding bits ENC0 and ENC1, and a respective CS signal CS1_n. The write command CMD may correspond to the write command 430 of FIG. 4. In the example, CS0_n=0, CS1_n=0, ENC0=0, and ENC1=0.

Responsive to the write command CMD, one or more memory devices in the first rank RANK0 determine that they are a target of the write command CMD based on the encoding bits ENC0 and ENC1 received via CA pins and a setting in a mode register, and the one or more memory devices in the first rank RANK0 set a termination resistance to perform a write operation responsive to the write command CMD. One or more memory devices in the second rank RANK1 determine that they are a non-target of the write command CMD based on the encoding bits ENC0 and ENC1 received via CA pins and a setting in a mode register, and the one or more memory devices in the second rank RANK1 set a termination resistance accordingly (e.g., for write non-target, based on the CS signal CS1_n).

FIG. 5C is a timing chart 520 illustrating controlling termination resistances using encoding bits according to some embodiments of the present disclosure. The timing chart illustrates various signals or commands, including a clock signal clk, CS signals CS0_n and CS1_n, read command CMD, encoding bit ENC0, and encoding bit ENC1. One or more memory devices in a first rank RANK0 receive the read command CMD, including encoding bits ENC0 and ENC1, and a respective CS signal CS0_n. One or more memory devices in a second rank RANK1 receive the read command CMD, including encoding bits ENC0 and ENC1, and a respective CS signal CS1_n. The read command CMD may correspond to the read command 440 of FIG. 4. In the example, CS0_n=0, CS1_n=0, ENC0=1, and ENC1=0.

Responsive to the read command CMD, one or more memory devices in the first rank RANK0 determine that they are a non-target of the read command CMD based on the encoding bits ENC0 and ENC1 received via CA pins and a setting in a mode register, and the one or more memory devices in the first rank RANK0 set a termination resistance accordingly (e.g., for read non-target, based on the CS signal CS0_n). One or more memory devices in the second rank RANK1 determine that they are a target of the read command CMD based on the encoding bits ENC0 and ENC1 received via CA pins and a setting in a mode register, and the one or more memory devices in the second rank RANK1 set a termination resistance to perform a read operation responsive to the read command CMD.

FIG. 5D is a timing chart 530 illustrating controlling termination resistances using encoding bits according to some embodiments of the present disclosure. The timing chart illustrates various signals or commands, including a clock signal clk, CS signals CS0_n and CS1_n, read command CMD, encoding bit ENC0, and encoding bit ENC1. One or more memory devices in a first rank RANK0 receive the read command CMD, including encoding bits ENC0 and ENC1, and a respective CS signal CS0_n. One or more memory devices in a second rank RANK1 receive the read command CMD, including encoding bits ENC0 and ENC1, and a respective CS signal CS1_n. The read command CMD may correspond to the read command 450 of FIG. 4. In the example, CS0_n=0, CS1_n=0, ENC0=1, and ENC1=1.

Responsive to the read command CMD, one or more memory devices in the first rank RANK0 determine that they are a non-target of the read command CMD based on the encoding bits ENC0 and ENC1 received via CA pins and a setting in a mode register, and the one or more memory devices in the first rank RANK0 set a termination resistance accordingly (e.g., for read non-target, based on the CS signal CS0_n). One or more memory devices in the second rank RANK1 also determine that they are a non-target of the read command CMD based on the encoding bits ENC0 and ENC1 received via CA pins and a setting in a mode register, and the one or more memory devices in the second rank RANK1 set a termination resistance accordingly (e.g., for read non-target, based on the CS signal CS1_n).

While two encoding bits ENC0 and ENC1 are shown in FIGS. 500-530, more or fewer encoding bits may be used in other embodiments. For example, one encoding bit can be used in embodiments where a memory system includes two ranks.

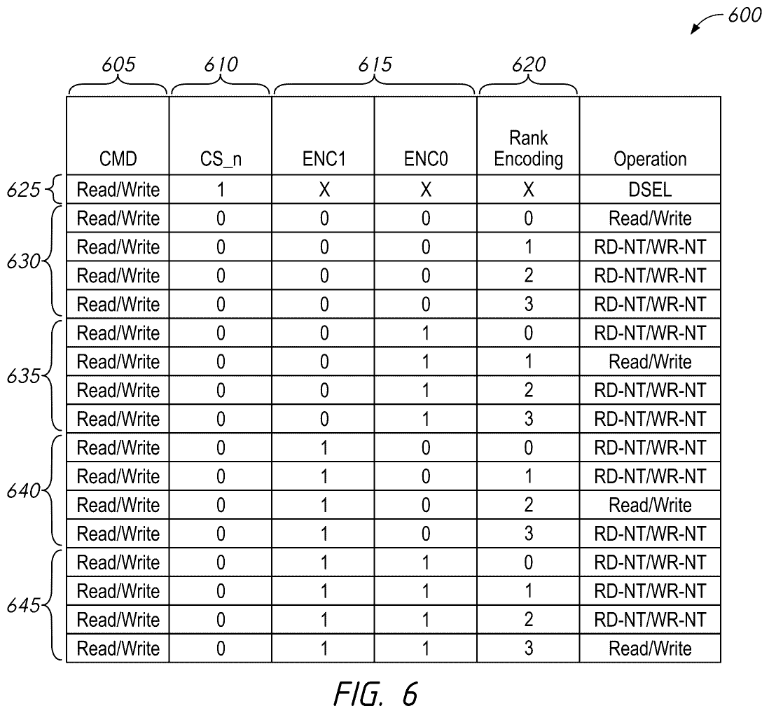

FIG. 6 is a table 600 illustrating controlling termination impedance using encoding bits according to some embodiments of the present disclosure. Various commands 605 are received by memory devices, which may be read commands or write commands. The commands 605 include respective CS signals 610, which may be provided to respective memory ranks, and the commands 605 include one or more encoding bits 615. The memory commands 605 are received by one or more memory devices having respective rank encodings 620 for respective memory ranks, which may include a first rank 0, a second rank 1, a third rank 2, and a fourth rank 3. Each memory rank may be configured to operate as a target responsive to different combinations of the encoding bits 615. For example, when ENC1=0 and ENC0=0, memory devices in the first rank 0 may operate as a target of a received command. When ENC1=0 and ENC0=1, memory devices in the second rank 1 may operate as a target of a received command. When ENC1=1 and ENC0=0, memory devices in the third rank 2 may operate as a target of a received command. When ENC1=1 and ENC0=1, memory devices in the fourth rank 3 may operate as a target of a received command. However, when a memory device in any rank receives a respective CS signal 610 at a logic high level, the memory device may evaluate a received command as a deselect (DSEL) command.

In a first example operation 625, a command 605 is received by one or more memory devices, and the command 605 includes a CS signal 610 at a logic high level (e.g., CS_n=1). Regardless of the value of the encoding bits 615, the one or more memory devices evaluate the command 605 as a DSEL command because the CS signal 610 is at the logic high level. The one or more memory devices may set a termination resistance for DSEL.

In a second example operation 630, a command 605 is received by one or more memory devices in each of rank 0, rank 1, rank 2, and rank 3, and respective CS signals 610 are received by the one or more memory devices of each rank at a logic low level (e.g., CS_n=0). The command 605 may be a read command or a write command, and the command 605 includes encoding bits 615. In the example operation 630, encoding bit ENC1=0 and encoding bit ENC0=0. Based on encoding bits ENC0 and ENC1, one or more memory devices in a first rank 0 determine (e.g., based on a setting in a mode register) that they are a target of the command 605, and the one or more memory devices in the first rank 0 set a termination resistance to perform an access operation responsive to the command. Also based on the encoding bits ENC0 and ENC1, one or more memory devices in the second rank 1, the third rank 2, and the fourth rank 3 determine that they are a non-target of the command 605, and the one more memory devices in the second rank 1, the third rank 2, and the fourth rank 3 set a termination resistance accordingly (e.g., for non-target read or non-target write).

In a third example operation 635, a command 605 is received by one or more memory devices in each of rank 0, rank 1, rank 2, and rank 3, and respective CS signals 610 are received by the one or more memory devices of each rank at a logic low level (e.g., CS_n=0). The command 605 may be a read command or a write command, and the command 605 includes encoding bits 615. In the example operation 635, encoding bit ENC1=0 and encoding bit ENC0=1. Based on encoding bits ENC0 and ENC1, one or more memory devices in a second rank 1 determine (e.g., based on a setting in a mode register) that they are a target of the command 605, and the one or more memory devices in the second rank 1 set a termination resistance to perform an access operation responsive to the command. Also based on the encoding bits ENC0 and ENC1, one or more memory devices in the first rank 0, the third rank 2, and the fourth rank 3 determine that they are a non-target of the command 605, and the one more memory devices in the first rank 0, the third rank 2, and the fourth rank 3 set a termination resistance accordingly (e.g., for non-target read or non-target write).

In a fourth example operation 640, a command 605 is received by one or more memory devices in each of rank 0, rank 1, rank 2, and rank 3, and respective CS signals 610 are received by the one or more memory devices of each rank at a logic low level (e.g., CS_n=0). The command 605 may be a read command or a write command, and the command 605 includes encoding bits 615. In the example operation 640, encoding bit ENC1=1 and encoding bit ENC0=0. Based on encoding bits ENC0 and ENC1, one or more memory devices in a third rank 2 determine (e.g., based on a setting in a mode register) that they are a target of the command 605, and the one or more memory devices in the third rank 2 set a termination resistance to perform an access operation responsive to the command. Also based on the encoding bits ENC0 and ENC1, one or more memory devices in the first rank 0, the second rank 1, and the fourth rank 3 determine that they are a non-target of the command 605, and the one more memory devices in the first rank 0, the second rank 1, and the fourth rank 3 set a termination resistance accordingly (e.g., for non-target read or non-target write).

In a fifth example operation 645, a command 605 is received by one or more memory devices in each of rank 0, rank 1, rank 2, and rank 3, and respective CS signals 610 are received by the one or more memory devices of each rank at a logic low level (e.g., CS_n=0). The command 605 may be a read command or a write command, and the command 605 includes encoding bits 615. In the example operation 640, encoding bit ENC1=1 and encoding bit ENC0=1. Based on encoding bits ENC0 and ENC1, one or more memory devices in a fourth rank 3 determine (e.g., based on a setting in a mode register) that they are a target of the command 605, and the one or more memory devices in the fourth rank 3 set a termination resistance to perform an access operation responsive to the command. Also based on the encoding bits ENC0 and ENC1, one or more memory devices in the first rank 0, the second rank 1, and the third rank 2 determine that they are a non-target of the command 605, and the one more memory devices in the first rank 0, the second rank 1, and the third rank 2 set a termination resistance accordingly (e.g., for non-target read or non-target write).

While examples have been described with two encoding bits 615 and four ranks having respective rank encodings 620, more or fewer ranks and/or encoding bits may be used. For example, in some implementations one encoding bit 615 and two ranks are used.

As used herein, an activation of a signal may refer to any portion of a signal waveform that a circuit responds to. For example, if a circuit responds to a rising edge, then a signal switching from a low level to a high level may be an activation. One example type of activation is a pulse, where a signal switches from a low level to a high level for a period of time, and then back to the low level. This may trigger circuits which respond to rising edges, falling edges, and/or signals being at a high logical level. One of skill in the art should understand that although embodiments may be described with respect to a particular type of activation used by a particular circuit (e.g., active high), other embodiments may use other types of activation (e.g., active low).

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method comprising:
receiving, at a memory and from a memory controller, an access command;
determining, based on at least one bit in the access command received via at least one command/address (CA) pin of the memory, whether the memory is a target for the access command; and
applying, by the memory, an on-die termination impedance based at least in part on the determination of whether the memory is the target for the access command.

2. The method of claim 1, wherein determining whether the memory is the target for the access command is based on comparing the at least one bit in the access command to at least one mode register bit in a mode register of the memory.

3. The method of claim 1, wherein the memory is associated with a rank of a plurality of ranks.

4. The method of claim 3, wherein the at least one bit comprises two bits and the plurality of ranks comprises four ranks.

5. The method of claim 1, further comprising:
receiving the access command at a second memory; and
applying, by the second memory, a different on-die termination impedance responsive to the access command, wherein the on-die termination impedance is configured in a mode register of the memory and the different on-die termination impedance is configured in a second mode register of the second memory.

6. The method of claim 5, wherein the memory is the target for the access command and the second memory is a non-target for the access command.

7. The method of claim 5, wherein the memory has a first rank and the second memory has a second rank.

8. The method of claim 1, further comprising:
performing, by the memory, an access operation responsive to the access command when the memory is the target for the access command.

9. The method of claim 1, wherein the determination of whether the memory is the target for the access command is made during a single clock cycle of the memory.

10. The method of claim 1, wherein the on-die termination impedance comprises one of RTT_NOM_RD, RTT_NOM_WR, RTT_PARK, RTT_WR, or DQS_RTT_PARK.

11. The method of claim 2, further comprising:
receiving a mode register write command; and
configuring the at least one mode register bit responsive to the mode register write command.

12. A system comprising:
a first memory device comprising a first on-die termination circuit;
a second memory device comprising a second on-die termination circuit; and
a controller configured to provide an access command to the first memory device and the second memory device, wherein each of the first memory device and the second memory device is configured to determine whether it is a target for the access command based on at least one bit in the access command received via a command/address (CA) pin, and wherein the first memory device is configured to apply a first on-die termination impedance to the first on-die termination circuit and the second memory device is configured to apply a second on-die termination impedance to the second on-die termination circuit responsive to the determination of whether each respective memory device is the target for the access command.

13. The system of claim 12, wherein the first memory device is configured to determine whether it is the target for the access command based on comparing the at least one bit in the access command to at least one mode register bit in a first mode register of the first memory device, and wherein the second memory device is configured to determine whether it is the target for the access command based on comparing the at least one bit in the access command to at least one mode register bit in a second mode register of the second memory device.

14. The system of claim 12, wherein the first memory device is associated with a first rank of a plurality of ranks and the second memory device is associated with a second rank of the plurality of ranks.

15. The system of claim 14, wherein the at least one bit comprises two bits and the plurality of ranks comprises four ranks.

16. The system of claim 12, wherein the first memory device is configured to determine, responsive to the access command, that it is the target of the access command and the second memory device is configured to determine, responsive to the access command, that it is a non-target of the access command.

17. The system of claim 12, wherein each of the first memory device and the second memory device is configured to perform the determination of whether it is the target for the access command during a single clock cycle.

18. The system of claim 12, wherein the first on-die termination impedance or the second on-die termination impedance comprises one of RTT_NOM_RD, RTT_NOM_WR, RTT_PARK, RTT_WR, or DQS_RTT_PARK.

19. The system of claim 13, wherein the controller is further configured to provide a mode register write command to the first memory device to configure the at least one mode register bit in the first mode register of the first memory device.

20. The system of claim 12, wherein the first memory device and the second memory device are included in a module.

21. An apparatus comprising:
a memory configured to:
receive an access command;
determine, based on at least one bit in the access command received via at least one command/address (CA) pin of the memory, whether the memory is a target for the access command; and
apply an on-die termination impedance based at least in part on the determination of whether the memory is the target for the access command.

22. The apparatus of claim 21, wherein the memory comprises a mode register, and wherein the memory is configured to determine whether it is the target for the access command based on comparing the at least one bit in the access command to at least one mode register bit programmed in the mode register.

23. The apparatus of claim 21, wherein the memory is associated with a rank of a plurality of ranks.
